(19) United States
(12) Patent Application Publication
(10) Pub. No.: US 2007/0084130 A1
(43) Pub. Date: Apr. 19, 2007

(54) Channel Assembly for a Vehicle Window

(76) Inventors: Mark D. Gaustad, Plymouth, MI (US); Stefano A. Frascaroli, Grosse Ile, MI (US); Denys Pryjma, Warren, MI (US); Richard A. Davis, Roseville, MI (US); Michael R. Peters, Washington Twp., MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/538,981

(22) Filed: Oct. 5, 2006

Related U.S. Application Data
(60) Provisional application No. 60/728,354, filed on Oct. 19, 2005.

(51) Int. Cl. B60J 5/04

(52) U.S. Cl. 49/502

(57) ABSTRACT

A channel assembly for a vehicle window comprises an upper channel, a lower channel, and a retention member connected to the upper channel. The retention member detachably connects the lower channel to the upper channel.

### RELATED APPLICATION(S)

This application claims the benefit of Provisional Application Ser. No. 60/728,354, filed Oct. 19, 2005.

### FIELD OF INVENTION

The present invention relates generally to a door assembly for a vehicle and, more particularly, to a door assembly having a channel assembly for a vehicle window.

### BACKGROUND

In many vehicles, entry regions such as doors include a movable window that may be opened and closed. When opened, the window is retracted into the door panel assembly of the door. A remaining aperture in the door then allows air to flow freely throughout the cabin of the vehicle or other ingress and egress as may be desired by a vehicle occupant. When closed, the window is moved from its retracted position in the door panel assembly to a sealing position with the perimeter of the aperture. A window guide system is commonly provided that helps facilitate movement of the window between the open and closed position through a series of channels that guide window movement and seal the window in its closed position.

### SUMMARY

A channel assembly for a vehicle window comprises an upper channel, a lower channel, and a retention member connected to the upper channel. The retention member detachably connects the lower channel to the upper channel.

### BRIEF DESCRIPTION OF THE DRAWINGS

The present invention will now be described, by way of example, with reference to the accompanying drawings, in which:

FIG. 1 is a plan view of a door assembly according to an embodiment of the invention;

FIG. 2 is a perspective cross-sectional view along the line II-II of FIG. 1;

FIG. 3 is a perspective view of a channel assembly according to an embodiment of the invention;

FIG. 4 is an exploded perspective view of a channel assembly according to an embodiment of the invention;

FIG. 5 is a perspective view of a channel assembly according to an embodiment of the invention;

FIG. 6 is a cross-sectional view along the line VI-VI in FIG. 5 according to an embodiment of the invention; and

FIG. 7 is a cross-sectional view along the line VII-VII in FIG. 5 according to an embodiment of the invention.

### DETAILED DESCRIPTION

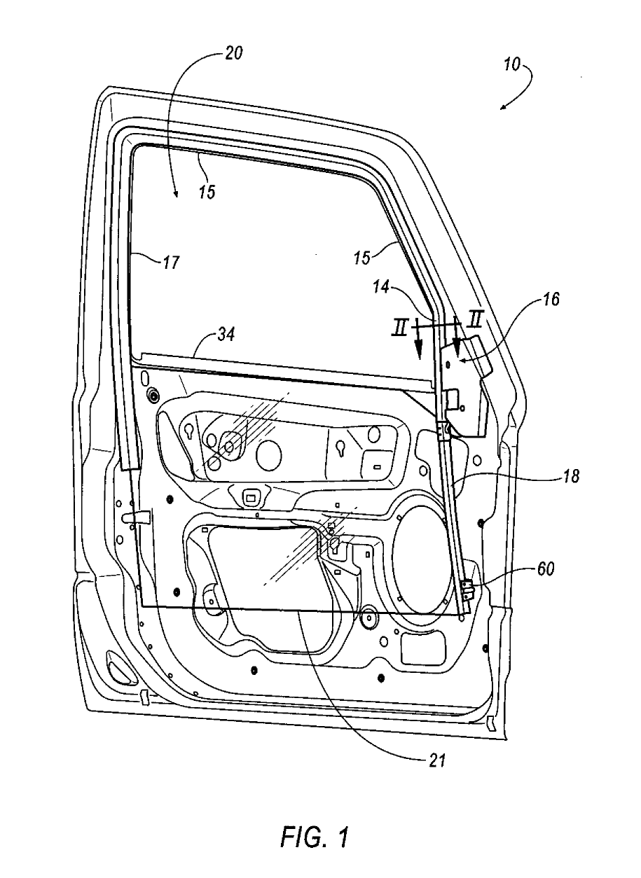

Referring now to FIG. 1, a channel assembly according to an embodiment of the invention is shown and described. In FIG. 1, a door 10 is shown having a window aperture 20 that allows ingress or egress from one side to the other side of the door 10. A window 21 is movable between a retracted or open position in the body of the door (as shown) to a closed position where the window fills the window aperture 20. An upper channel assembly, is provided that includes upper channel 14, sealing portions 15, guiding portions 17 and reinforcement bracket 16. A lower channel 18 is also provided. The upper channel assembly and lower channel 18 guide the window 21 between the open and closed positions and help seal the window 21 when in the closed position.

The upper channel assembly generally includes upper channel 14 positioned at the periphery of the window aperture 20 and a reinforcement bracket 16 that is attached to portions of the door 10 as will be described. Sealing portions 15 seal the window 21 when in the closed position and guiding portions 17 guide the window 21 between the closed and open positions as well as help seal the window 21 when in the closed position.

In an embodiment, lower channel 18 extends substantially vertical with respect to a normal orientation of the door 10. The lower channel 18 can be connected to the door 10 by a connector, such as lower connector 60, and can be connected to upper channel 14, for example by reinforcement bracket 16. Guiding portion 17 and upper channel 14 can cooperate with the lower channel 18 to facilitate and guide movement of the window 21 between its closed and open positions.

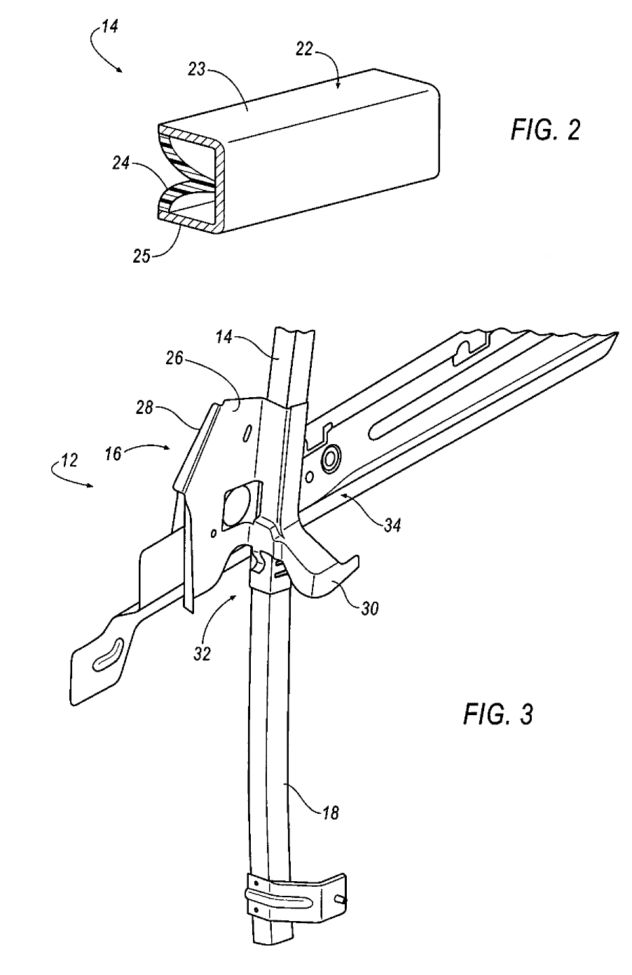

Referring now to FIG. 2, a perspective cross-sectional view take along line II-II in FIG. 1 illustrates an embodiment of the upper channel 14 in greater detail. It will be understood that, in embodiments, the associated guiding portion 17, sealing portions 15 and lower channel 18 may have substantially the same configuration as that described with respect to FIG. 2.

The upper channel 14 includes window guide 22 and window seal 24. In the illustrated embodiment, the window guide 22, includes opposing walls 23 and 25. The window seal 24 has a slot or formation that is adapted to receive an edge of window 21 to seal the window 21 when it is positioned in connection therewith. One skilled in the art will understand that modifications and variations may exist with respect to the window seal 24.

Referring now to FIG. 3, a portion of an upper channel assembly 12 is described in greater detail. A reinforcement bracket 16 is connected to a lower frame member 34 of the door 10 (see e.g., FIG. 1) and to upper channel 14. The reinforcement bracket 16 can include a mirror support 30 that, may extend from the door 10 to support a rearview mirror. The upper channel 14 can be connected to the lower channel 18 at or about a connection area 32 as will be described.

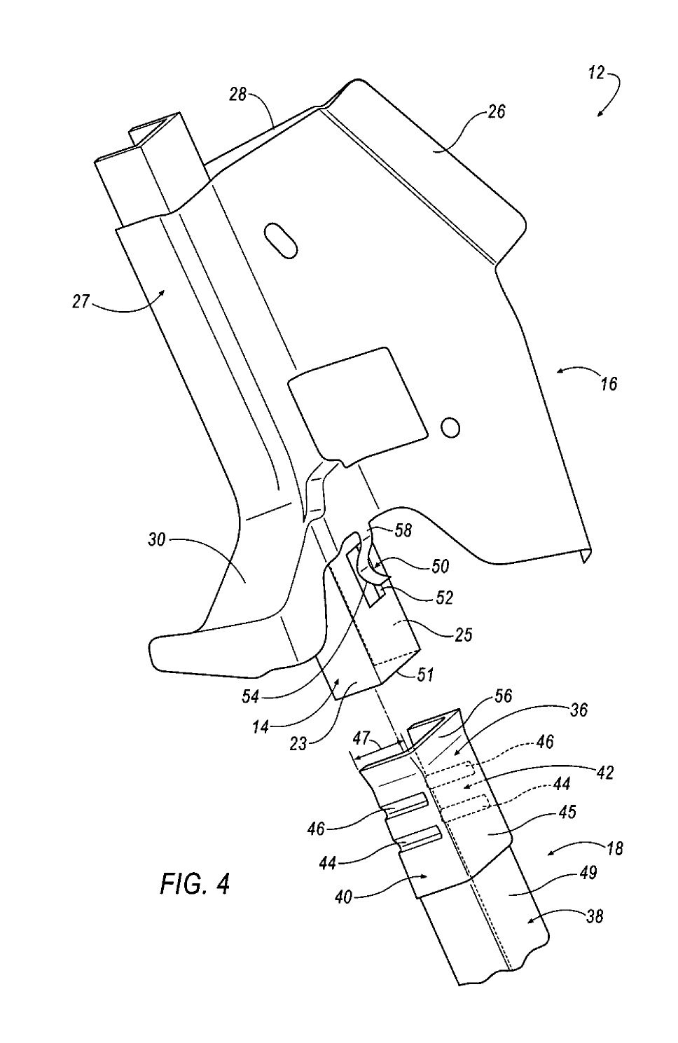

Referring now to FIG. 4, an exploded perspective view of the upper channel of upper channel assembly and lower channel 18 is shown and described. It will be understood that the illustration shown in FIG. 4 is simply one embodiment of the upper channel 14 and lower channel 18 before assembly.

FIG. 4 illustrates a perspective view of an embodiment of an upper channel 14 and lower channel 18 in an unconnected state. In FIG. 4, reinforcement bracket 16 generally includes a first reinforcement portion 26 and a second reinforcement portion 28. The first reinforcement portion 26 includes an encapsulating region 27 that encompasses a portion of the outer surface of the upper channel 14. In an embodiment, the first reinforcement portion 26 is connected to the second reinforcement portion 28, for example, by welding or other known means for connection. Similarly, the first reinforcement portion 26 and the second reinforcement portion 28 may be connected to the lower frame member 34 (see e.g., FIGS. 1 and 3) through welding or other known means for connection.

A clip 50 may extend from first reinforcement portion 26 along the upper channel 14. The clip 50 may include an entrance 54 and a resilient or spring-loaded region 58. The entrance 54 helps facilitate entry of an edge portion of the lower channel 18, and the resilient or spring-loaded region 58 permits the clip 52 to flex and permits the edge of the lower channel 18 to pass between the clip 50 and the upper channel 14. It will be understood that clip 50 may be any retention formation or member that engages the lower channel 18 and is not limited to the embodiments discussed herein. In the illustrated embodiment, clip 50 is integrally formed with the first reinforcement portion 26. However, one skilled in the art will readily recognize and appreciate that other means for connecting the clip 50 to the first reinforcement portion 26 are contemplated.

It will be noted that, although one clip 50 is shown, multiple clips may be used in connection with the embodiments of the invention. For example, another clip may be positioned on an opposite side of the upper channel 14 from the clip 50 shown. Such a configuration may assist in the reduction of rattle or vibration. Additionally, clips may be positioned on all sides of the upper channel 14. The clip 50 may also be formed on the lower channel 18. One skilled in the art will readily understand additional configurations for the clip 50.

In an embodiment, an aperture 52 is positioned in the upper channel 14 at a location adjacent to the clip 50. In an embodiment, the aperture 52 allows drainage of paint or other coatings that may be applied to the clip 50. Such drainage can assist in preventing solidified material from forming between the clip 50 and the upper channel 14.

With continued reference to FIG. 4, the lower channel 18 can include an expanded region 36 generally positioned at an end of the lower channel 18 proximate to the upper channel 14 and reinforcement bracket 16. In the illustrated embodiment, the expanded region 36 includes expanded region opposing walls 40 and 42 having a width therebetween that is greater than a distance between the opposing walls 23 and 25 of the upper channel 14. Similarly, an edgewise length 47 of the expanded region opposing walls 40 and 42 is greater than and edgewise length of the upper channel 14 that, in connection with the increased width of the opposing walls 23 and 25, allows the expanded region 36 to slide over and encompass a portion of the upper channel 14.

In an embodiment, each of the expanded region opposing walls 40 and 42 includes a respective upper detent 46 and lower detent 44. Each of the detents 46 and 44 extended from the respective expanded region opposing wall 40 or 42 toward an interior of the expanded region 36. The operation of the detents 46 and 44 for the exemplary embodiment will be described in greater detail below. As illustrated, two detents may be included on each wall 40 or 42. The use of two detents assists in limiting rotation of the lower channel 18 with respect to the upper channel 14. However, one skilled in the art will understand that any number of detents or no detents at all may be used in connection with embodiments of the invention.

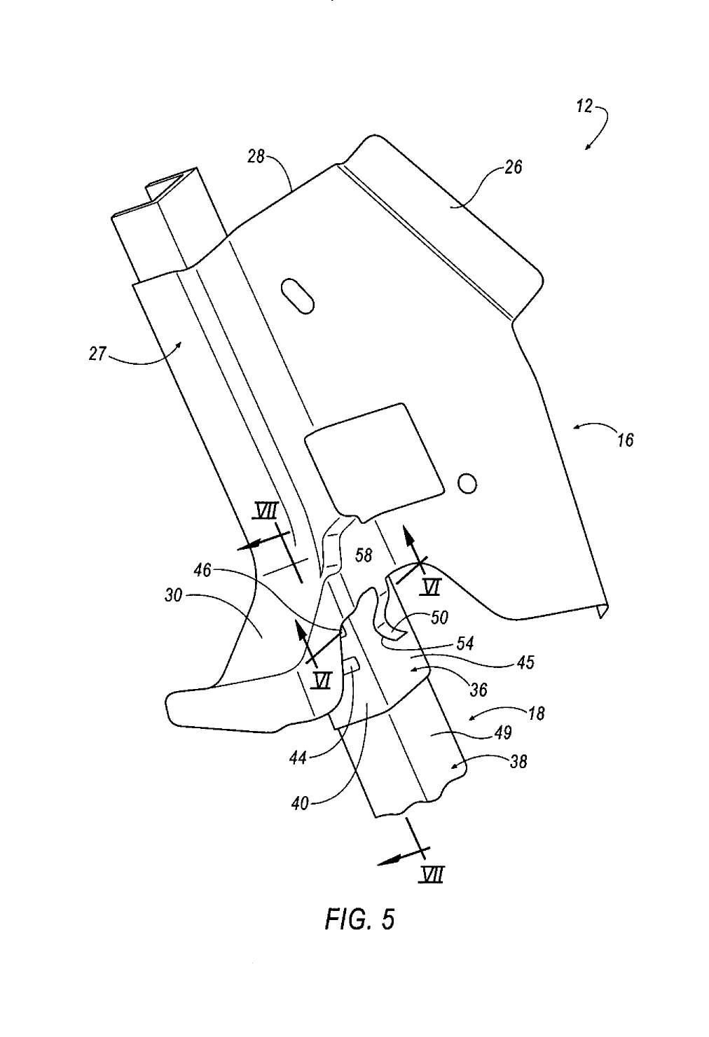

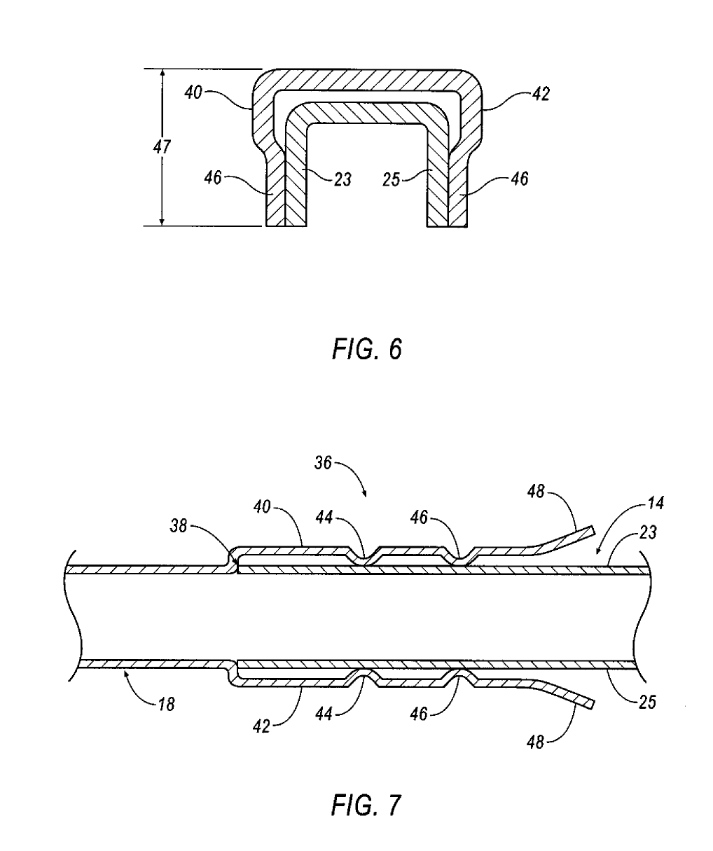

Referring now to FIGS. 5-7, an embodiment of the assembly of lower channel 18 to upper channel 14 is shown and described. During assembly, the lower channel 18 is moved from the position shown in FIG. 4 to that shown in FIG. 5. At the start of this operation, a formation, such as a chamfer 48 (see e.g., FIG. 7), is started over an edge 51 of the upper channel 14. During this operation, the expanded region 36 is slid over the lower channel 14 to allow the edge 56 of the lower channel 18 to be pressed against the entrance 54 of the clip 50. This pressing action deflects the clip 50 away from the upper channel 14 to allow the bottom 45 to slide between the clip 50 and the upper channel 14. Also during this operation, upper detents 46 and lower detents 44 pass over opposing walls 23 and 25. The expanded region 36 is slid over the upper channel 14 until upper channel 14 abuts against the channel region 38 (See e.g., FIG. 7) of the lower channel 14. As can be seen from FIG. 5, the clip 50 frictionally presses the bottom 45 against the upper channel 14. As shown in FIG. 7, upper detents 46 and lower detents 44 frictionally engage opposing walls 23 and 25.

The expanded region 36 provides an increased dimensioned area to allow connection of the upper channel 14 and lower channel 18. Additionally, as only the expanded region 36 includes such increased dimensions, the remainder of the lower channel 18 can, if desired, retain substantially the same dimensions as the upper channel 14. (such as distance between opposing walls 23 and 25). Accordingly, one continuous window seal 24 (see e.g., FIG. 2) may pass from the upper channel 14 to the lower channel 18 without the need for breaking or otherwise separating the seal to accommodate for variations in the dimensions of the upper channel 14 or lower channel 18.

When the lower channel 18 is engaged with the upper channel 14, lower connector 60 may then be attached to the door 10 (see e.g., FIG. 1).

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

what is claimed is:

1. A channel assembly for a vehicle window, comprising:
an upper channel;
a lower channel; and
a retention member connected to the upper channel;
wherein the retention member detachably connects the lower channel to the upper channel.

2. The channel assembly according to claim 1, further comprising a reinforcement bracket connected to the upper channel.

3. The channel assembly according to claim 2, wherein the retention member is connected to the reinforcement bracket.

4. The channel assembly according to claim 3, wherein the retention member is integrally formed with the reinforcement bracket.

5. The channel assembly according to claim 2, wherein:
the retention member includes a clip; and
a portion of the lower channel is engaged between the clip and the upper channel.

6. The channel assembly according to claim 5, wherein the upper channel includes an aperture proximate the clip.

7. The channel assembly according to claim 2, wherein:
the lower channel comprises an expanded region at an end of the lower channel proximate the upper channel; and
the expanded region is positioned over an outside portion of the upper channel.

8. The channel assembly according to claim 7, wherein:
the upper channel comprises at least two upper channel opposing walls; and
the expanded region comprises at least two expanded region opposing walls positioned outside the upper channel opposing walls.

9. The channel assembly according to claim 8, wherein:
each of the two expanded region opposing walls comprises at least two detents; and
the two detents of each of the expanded region opposing walls engage a respective one of the upper channel opposing walls.

10. The channel assembly according to claim 9, wherein:
the two detents of each of the expanded region opposing walls are positioned substantially opposite to the two detents of another of the upper channel opposing walls.

11. The channel assembly according to claim 2, further comprising a window seal supported by the upper channel and the lower channel.

12. The channel assembly according to claim 11, wherein the window seal extends substantially continuously from the lower channel to the upper channel.

13. A vehicle door, comprising:
a channel assembly comprising:
an upper channel;
a lower channel; and
a retention member connected to the upper channel;
wherein the retention member detachably connects the lower channel to the upper channel.

14. The vehicle door according to claim 13, further comprising a reinforcement bracket connected to the upper channel.

15. The vehicle door according to claim 14, wherein:
the retention member is a clip; and
a portion of the lower channel is frictionally engaged between the clip and the upper channel.

16. The vehicle door according to claim 15, further comprising a window seal supported by the upper channel and the lower channel.

17. The vehicle door according to claim 16, wherein the window seal extends continuously from the lower channel to the upper channel.

18. A method for assembling a lower channel and an upper channel of a door, comprising:
providing the upper channel, wherein the upper channel includes a retention member; and
inserting the lower channel into the upper channel such that the retention member detachably connects the lower channel to the upper channel.

19. The method according to claim 18, further comprising a reinforcement bracket connected to the upper channel.

20. The method according to claim 19, wherein:
the retention member includes a clip; and
a portion of the lower channel is engaged between the clip and the upper channel.
